(19) United States
(12) Patent Application Publication
(10) Pub. No.: US 2004/0107793 A1
(43) Pub. Date: Jun. 10, 2004

(54) Flywheel structure

(76) Inventor: Douglas Chiang, Taipei (TW)

Correspondence Address: Douglas Chiang, PO Box 82-144, Taipei, TW

(21) Appl. No.: 10/309,030

(22) Filed: Dec. 4, 2002

(51) Int. Cl. G05G 1/00

(52) U.S. Cl. 74/572

(57) ABSTRACT

This invention is directed to an improved flywheel structure capable of shortening rotation travel and having a relatively long service life. The flywheel structure includes a first ratchet pawl set having a plurality of equidistantly spaced apart ratchet flocks and fitted to the periphery of a wheel seat. The wheel seat has fitted therein a tooth disk which has ratchet teeth on the periphery thereof so that the tooth disk can engage or rotate reversely relative to the tooth disk. The invention is characterized in that a second ratchet pawl set is formed on the wheel seat and has a set of series equidistantly spaced apart ratchet blocks. The ratchet blocks of the second ratchet pawl set and the ratchet blocks of the first ratchet pawl set are staggered. The second ratchet pawl set is located within range of one ratchet tooth width at the inner edge of the tooth disk of forward or rearward displacement of equidistant angle of the first ratchet pawl set. Through the above design, the idle rotation distance when the tooth disk intends to rotate forward after reverse rotation can be effectively shortened, thereby reducing rotational impact and power transmission distortion, and enhancing feel of pedaling.

### BACKGROUND OF THE INVENTION

1. Field of the Invention

This invention is related to an improvement in the structure of a flywheel.

2. Description of the Prior Art

A flywheel structure generally used in a bicycle or a stationary bicycle is shown in FIG. 1. A ratchet pawl set is provided on a wheel seat 10. The ratchet pawl set has three equidistantly spaced apart tooth grooves 11 formed on the wheel seat 10. A tightening ring 13 is used to retain ratchet blocks 12 in tooth grooves 11 respectively. A tooth disk 15 is fitted on wheel seat 10 by means of a wheel cover 19. The inner edge of tooth disk 15 is formed with a series ratchet tooth 16 corresponding to ratchet blocks 12 to enable tooth disk 15 to engage or rotate relative to wheel seat 10. Ball bowl sets 17, 18 are respectively disposed among tooth disk 15 and wheel seat 10 and wheel cover 19 to ensure smooth rotation.

The above flywheel structure does not have much problem in operation and rotation. However, there are some problems during the process of switching from rotation to engagement. As shown in FIG. 2, when tooth disk 15 reversely rotates one half of the distance of ratchet tooth 16 relative to the wheel seat 10, if tooth disk 15 is to rotate reversely to engage wheel seat 10, tooth disk 15 must rotate idly half the width of ratchet tooth 16 before it can smoothly engage therewith. Besides, as shown in FIG. 3, when tooth disk 15 reversely rotates three-quarters of the width of ratchet tooth 16 relative to wheel seat 10, then tooth disk 15 must rotate idly three-quarters of the width of ratchet tooth 16 in order to smoothly engage therewith.

Since the travel of reverse rotation is relatively long, the impact generated will be relatively large, which may result in damage to ratchet blocks 12 or ratchet tooth 16 and may shorten the service life thereof. Further the reaction and start are relatively slow. For users, there will be the phenomenon of power transmission distortion so that the feel of pedaling is not satisfactory.

### SUMMARY OF THE INVENTION

The invention realizes the aforesaid object and effects through the following technical means: the flywheel structure includes ratchet pawl sets provided on a wheel seat and formed by series ratchet blocks, a tooth disk being fitted on the wheel seat by using a wheel cover, the inner edge of the tooth disk being formed with a series ratchet tooth corresponding to the ratchet pawl sets to enable the tooth disk to engage or rotate reversely relative to the wheel seat, characterized in that: the wheel seat that is provided with at least two ratchet pawl sets, the ratchet blocks of each ratchet pawl set being equidistantly spaced apart, the position of the ratchet blocks of adjacent ratchet pawl sets engaging the ratchet tooth of the tooth disk displacing within range of the width of one ratchet tooth; whereby, when ratchet blocks of a front ratchet pawl set engage the ratchet tooth of the tooth disk, the ratchet blocks of a rear ratchet pawl set will displace within the range of the ratchet tooth, thereby shortening rotation travel and enhancing feel of power transmission.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The foregoing and other features and advantages of the present invention will be more clearly understood from the following detailed description and the accompanying drawings, in which,

FIG. 1 is a schematic perspective exploded view of the conventional flywheel structure;

FIG. 2 is a schematic plan view illustrating operation of the conventional flywheel structure;

FIG. 3 is another schematic plan view illustrating the operation of the conventional flywheel structure;

FIG. 4 is an exploded perspective view of the flywheel structure of the invention, showing the form and corresponding positions of the components of the invention;

FIG. 5 is a schematic plan view illustrating operation of the flywheel structure of the invention, showing the actual operating state and relative relationship of the flywheel structure; and

FIG. 6 is another schematic plan view showing the operation of the flywheel structure of the invention, further illustrating the actual operating state and relative relationship of the flywheel structure.

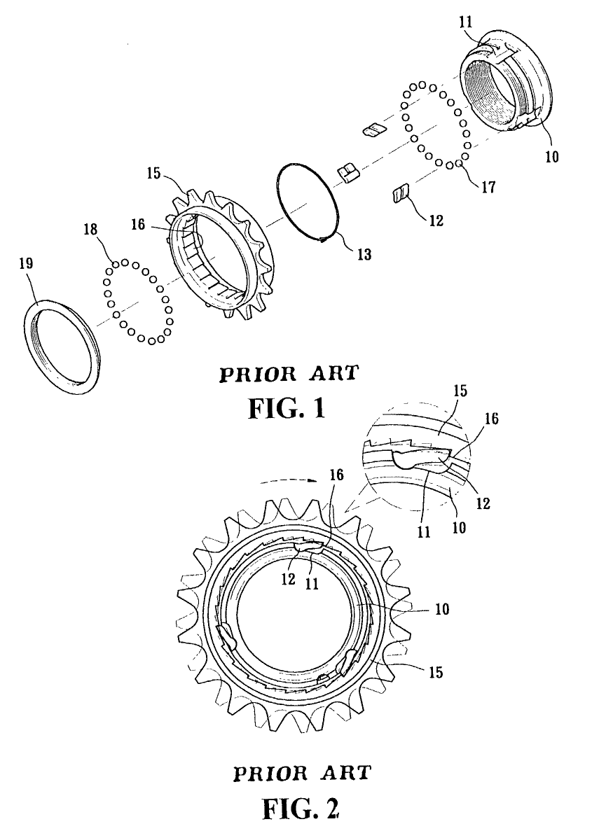

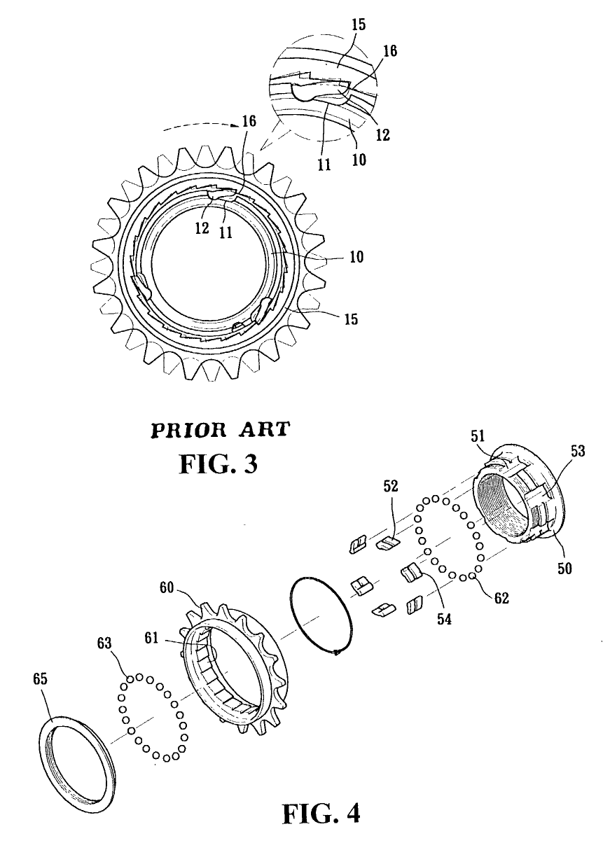

### DETALED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The invention is directed to an improved flywheel structure capable of shortening reverse rotation travel and prolonging service life. As shown in FIG. 4, the flywheel structure is provided with ratchet pawl sets on a wheel seat 50. A tooth disk 60 is fitted on wheel seat 50 by using a wheel cover 65. The inner edge of tooth disk 60 is formed with a series ratchet tooth 61 corresponding to the ratchet pawl set to enable tooth disk 60 to engage or reversely rotate relative to wheel seat 50. Ball bowl sets 62, 63 are respectively disposed among tooth disk 60 and wheel seat 50 and wheel cover 65 so as to maintain smooth rotation. As the above-described flywheel structure and operating principle are the same as those of existing structures and are not features of the invention, they will not be described in detail.

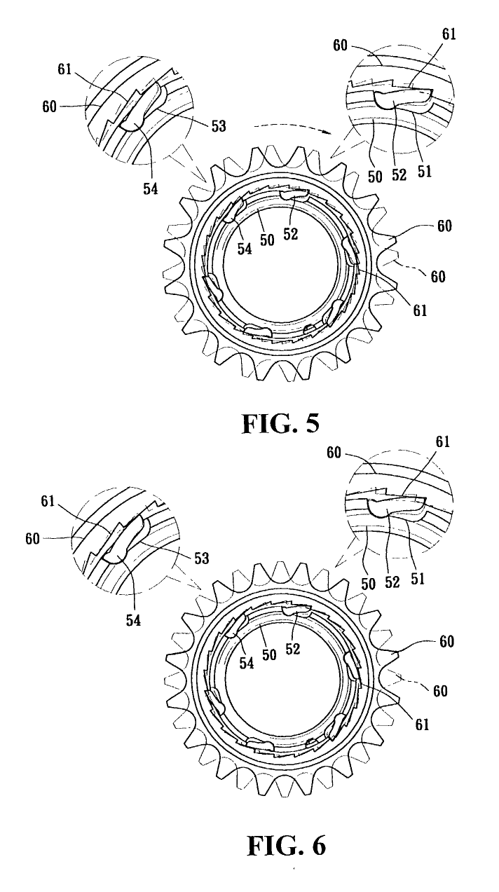

Referring to FIG. 4, wheel seat 50 is provided with at least two ratchet pawl sets. The invention is exemplified using two sets in this embodiment. The first ratchet pawl seat has a plurality of equidistantly spaced apart first tooth grooves 51 formed on wheel seat 50. Three tooth grooves are provided in this embodiment. The angle between two adjacent tooth grooves is 120 degrees. Each first tooth groove 51 is provided with a first ratchet block 52. The second ratchet pawl set also has series equidistantly spaced apart second tooth grooves 53 formed at the periphery of wheel seat 50. Three tooth grooves are likewise used in this embodiment, and the angle between two adjacent tooth grooves is 120 degrees. Second ratchet blocks 54 and first ratchet blocks 52 of first ratchet pawl set are arranged in a stagger manner. Second ratchet blocks 54 are provided to displace forward or rearward within the range of the width of one ratchet tooth 61 when first ratchet blocks 52 engage ratchet tooth 61, and, in this embodiment, displace one half of the width of ratchet tooth 61 (as shown in FIG. 5).

Therefore, when first ratchet blocks 52 of first ratchet pawl set engage ratchet tooth 61 of tooth disk 60, second ratchet blocks 54 of second ratchet pawl set are in a position corresponding to one half of ratchet tooth 61, thereby accomplishing the improved flywheel structure, which can reduce reverse rotation travel and enhance power transmission feel.

Referring to FIGS. 5 and 6, if the flywheel structure has to rotate after reverse rotation, and when first ratchet blocks 52 of first ratchet pawl set engage with ratchet tooth 61, second ratchet blocks 54 of second ratchet pawl set are at one half of ratchet tooth 61. Conversely, when first ratchet blocks 52 of first ratchet pawl set are at one half of ratchet tooth 61, second ratchet blocks 54 can engage ratchet tooth 61. There is no need to go through the travel of rotation and idle rotation.

For the same reasons, the relative rotation travel of tooth disk 60 and wheel seat 50 is reduced to within the range of one half of ratchet tooth 61. Hence, the impact produced is relatively small, and ratchet tooth 61, ratchet blocks 52, 54 can be protected against impact to prevent damage thereto to thereby prolong their service life. Further, since the travel of rotation is shortened, the reaction speed is fast, and the start reaction is also relatively quick. At the same time, the power transmission will not be distorted during pedaling, thereby effectively enhancing the economic value of the flywheel structure.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved flywheel structure, said flywheel structure comprising ratchet pawl sets provided on a wheel seat and formed by series ratchet blocks, a tooth disk being fitted on said wheel seat by using a wheel cover, the inner edge of said tooth disk being formed with a series ratchet tooth corresponding to said ratchet pawl sets to enable said tooth disk to engage or rotate reversely relative to said wheel seat, characterized in that: said wheel seat is provided with at least two ratchet pawl sets, the ratchet blocks of each ratchet pawl set being equidistantly spaced apart, the position of the ratchet blocks of adjacent ratchet pawl sets engaging said ratchet tooth of said tooth disk displacing within range of the width of one ratchet tooth, whereby when ratchet blocks of a front ratchet pawl set engage said ratchet tooth of said tooth disk, said ratchet blocks of a rear ratchet pawl set will displace within the range of said ratchet tooth, thereby shortening rotation travel and enhancing feel of power transmission.

2. The improved flywheel structure as claimed in claim 1, wherein said wheel seat is provided with two sets of ratchet pawls, wherein said first ratchet pawl has a plurality of equidistantly spaced apart first tooth grooves formed on said wheel seat, each of said first tooth grooves being provided with a first ratchet block, said second ratchet pawl sets having series and equidistantly spaced apart second tooth grooves formed on the periphery of said wheel seat, each of said second tooth grooves being provided with a second ratchet block, said second ratchet block displacing forward or rearward one half of the width of said ratchet tooth when said first ratchet block engage said ratchet tooth, thereby shortening rotation travel of said tooth disk.

3. The improved flywheel structure as claimed in claim 1, wherein each of said ratchet pawl set is configured to have three ratchet blocks, with an angle of 120 degrees between adjacent ratchet blocks.
